(19) United States
(12) Patent Application Publication
(10) Pub. No.: US 2020/0254939 A1
(43) Pub. Date: Aug. 13, 2020

(54) CUSTOMIZABLE VEHICLE ATTACHMENT APPARATUS

(71) Applicant: Mark Brown, Baker, LA (US)

(72) Inventor: Mark Brown, Baker, LA (US)

(21) Appl. No.: 16/271,180

(22) Filed: Feb. 8, 2019

(51) Int. Cl. B60R 11/00; A47C 7/66; A47C 3/18; A47C 1/14; A47J 37/07

(52) U.S. Cl. CPC B60R 11/00; A47C 7/664; B60R 2011/004; A47C 1/146; A47J 37/07; A47C 3/18

(57) ABSTRACT

A vehicle attachment apparatus, including an elongated member removably connected to a hitch of a vehicle, an umbrella removably connected to the elongated member to provide shade for a user that is positioned under the umbrella, and a seat attachment removably connected to the elongated member to support the user seated thereupon.

### BACKGROUND

### 1. Field

The present general inventive concept relates generally to an attachment apparatus, and particularly, to a customizable vehicle attachment apparatus.

### 2. Description of the Related Art

A vehicle such as a pickup truck is a versatile vehicle that may be used to haul loads in a pickup truck bed. During other occasions, the pickup truck can be the perfect companion for a tailgate party, which is also known as tailgating. Tailgating accessories are a necessity to ensure a great time.

Unfortunately, people who enjoy tailgating usually sit in the pickup truck bed and may need to bring a table and a means to cook food. Furthermore, people sitting in the pickup truck bed and/or standing nearby may be constantly exposed to intense heat from the Sun.

Therefore, there is a need for an apparatus that connects to a vehicle and includes at least one seat and a removable umbrella.

### SUMMARY

The present general inventive concept provides a customizable vehicle attachment apparatus.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a vehicle attachment apparatus, including an elongated member removably connected to a hitch of a vehicle, an umbrella removably connected to the elongated member to provide shade for a user that is positioned under the umbrella, and a seat attachment removably connected to the elongated member to support the user seated thereupon.

The seat attachment may include at least one seat removably connected to the seat attachment to enable the user to sit.

The at least one seat may swivel in response to the user applying a force thereto.

The seat attachment may further include an attachment bar disposed transversely on top of the elongated member to support the at least one seat.

The foregoing and/or other features and utilities of the present general inventive concept may also be achieved by providing a vehicle attachment apparatus, including an elongated member removably connected to a hitch of a vehicle, a support member connected to an end of the elongated member to provide vertical support therefor, and at least one seat attachment removably connected to the elongated member to support the user in response to the user sitting thereon.

The elongated member may include an extended member removably connected to a portion of the elongated member to extend a length of the elongated member.

A first end of the extended member may be removably connected to the end of the elongated member, and a second end of the extended member may be connected to the support member.

The at least one seat attachment may include at least one seat removably connected to the at least one seat attachment to enable the user to sit.

The extended member may support at least one of a grill and a table.

The vehicle attachment apparatus may further include an umbrella removably connected to the elongated member to provide shade for a user that is positioned under the umbrella.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side elevational view of a customizable vehicle attachment apparatus, according to an exemplary embodiment of the present general inventive concept; and

FIG. 2 illustrates a front elevational view of a customizable vehicle attachment apparatus, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

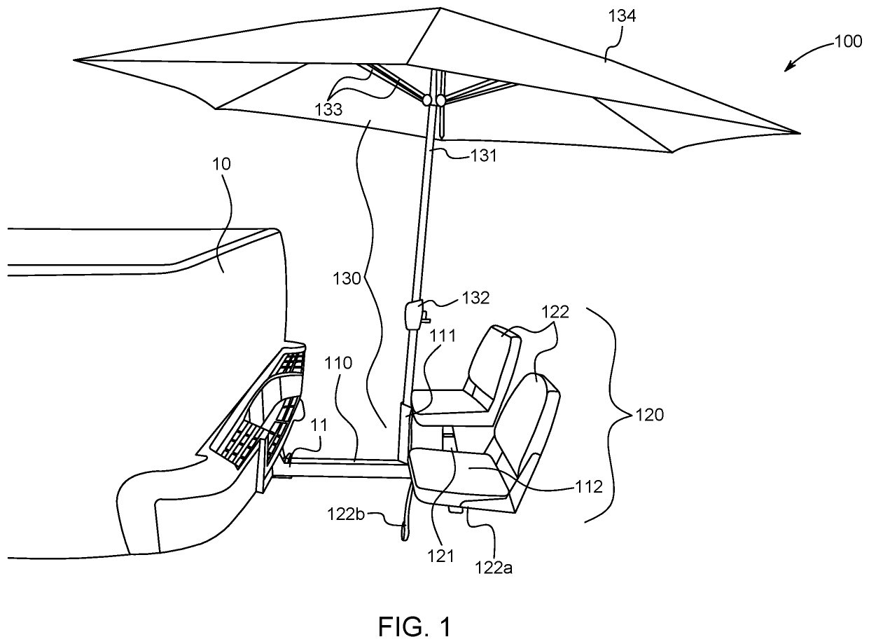

FIG. 1 illustrates a side elevational view of a customizable vehicle attachment apparatus 100, according to an exemplary embodiment of the present general inventive concept.

The customizable vehicle attachment apparatus 100 may be constructed from at least one of metal, plastic, wood, glass, and rubber, etc., but is not limited thereto.

The customizable vehicle attachment apparatus 100 may include an elongated member 110, a seat attachment 120, and an umbrella 130, but is not limited thereto.

The elongated member 110 may include an umbrella-receiving aperture 111 and a seat attachment-receiving slot 112, but is not limited thereto.

Referring to FIG. 1, the elongated member 110 is illustrated to have a rectangular prism shape. However, the elongated member 110 may be a circular prism, a pentagonal prism, a hexagonal prism, an octagonal prism, or any other shape known to one of ordinary skill in the art, but is not limited thereto.

The elongated member 110 may be removably connected to a hitch 11 of a vehicle 10. The umbrella-receiving aperture 111 may be disposed on at least a portion of the elongated member 110 between an end of the elongated member 110 within the hitch 11 and an opposing end of the elongated member 110 with respect to the hitch 11. Additionally, the umbrella-receiving aperture 111 may extend vertically from the elongated member 110 away from a ground surface.

The seat attachment-receiving slot 112 may be disposed on at least a portion of the elongated member 110 between the end of the elongated member 110 within the hitch 11 and the opposing end of the elongated member 110 with respect to the hitch 11.

The seat attachment 120 may include an attachment bar 121 and at least one seat 122, but is not limited thereto.

The at least one seat 122 may include a joint 122a and an adjustment lever 122b, but is not limited thereto.

The seat attachment 120 may be removably connected to the seat attachment-receiving slot 112 of the elongated member 110. Specifically, at least a portion of the attachment bar 121 may be inserted into the seat attachment-receiving slot 112, and may be secured using a locking mechanism. As such, the attachment bar 121 may be disposed transversely on top of the elongated member 110 (i.e., to form a “+”), but is not limited thereto.

The at least one seat 122 may be removably connected to the attachment bar 121. Specifically, the at least one seat 122 may be connected at the joint 122a. The at least one seat 122 may swivel in response to a user pushing and/or pulling the at least one seat 122. The seat attachment 120 may support the user in response to the user sitting thereon. Specifically, the at least one seat 122 may enable the user to sit.

Also, the user may prevent the seat 122 from swiveling by shifting the adjustment lever 122b in a first direction or a second direction from a first position (i.e. unlocked) to a second position (i.e. locked). The user may release the seat 122 by shifting the adjustment lever in the second direction or the first direction from the second position to the first position.

The umbrella 130 may include a pole 131, a handle 132, a plurality of stretchers 133, and a canopy 134.

The pole 131 may be removably inserted into the umbrella-receiving aperture 111. The user may rotate the handle 132 in a first direction (i.e. clockwise) or a second direction (i.e. counterclockwise) to raise the plurality of stretchers 133 from a first position to a second position. As such, the plurality of stretchers 133 may change the canopy 134 from a first orientation (i.e. closed) to a second orientation (i.e. opened). Therefore, the canopy 134 may cover the user that is positioned under the canopy 134, such that the user has shade. In other words, the canopy 134 provide shade for the user who is disposed beneath the canopy 134. The user may close the canopy 134 by rotating the handle 132 in the second direction or the first direction, such that the plurality of stretchers 133 moves from the second position to the first position.

The customizable vehicle attachment apparatus 100 may be a convenient way to host a social gathering. Specifically, the user may sit on the at least one seat 122 instead of on and/or within the vehicle 10 to relax.

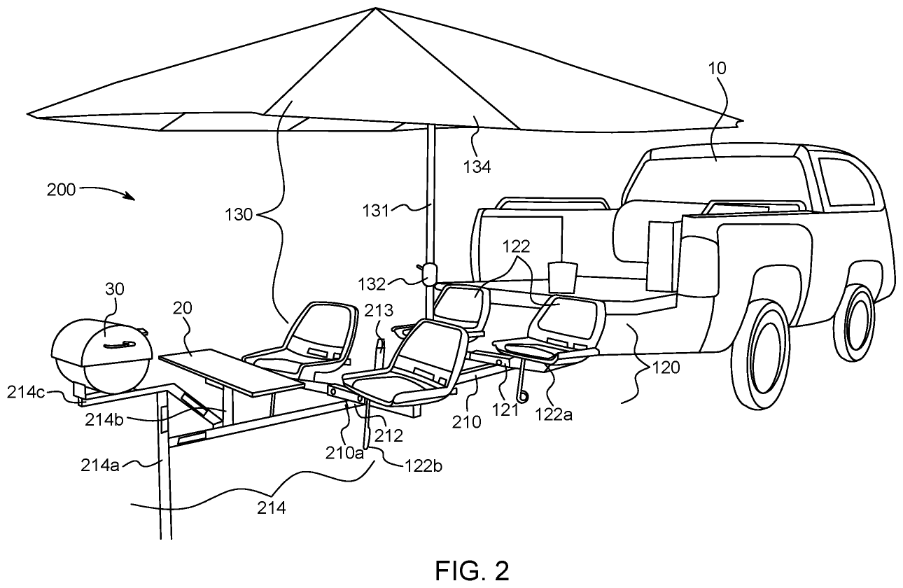

FIG. 2 illustrates a front elevational view of a customizable vehicle attachment apparatus 200, according to another exemplary embodiment of the present general inventive concept.

The customizable vehicle attachment apparatus 200 may be constructed from at least one of metal, plastic, wood, glass, and rubber, etc., but is not limited thereto.

The customizable vehicle attachment apparatus 200 may include an elongated member 210, a seat attachment 120, and an umbrella 130, but is not limited thereto.

Referring to FIGS. 1 and 2, the elongated member 210 may have many components similar to the elongated member 110. As such, the elongated member 210 may include an aperture 210a, an umbrella-receiving aperture 211, at least one seat attachment-receiving slot 212, an extended handle 213, and an extended member 214, but is not limited thereto.

Referring to FIG. 1, the elongated member 210 is illustrated to have a rectangular prism shape. However, the elongated member 210 may be a circular prism, a pentagonal prism, a hexagonal prism, an octagonal prism, or any other shape known to one of ordinary skill in the art, but is not limited thereto.

Referring to FIGS. 1 and 2, the elongated member 210 may be removably connected to the hitch 11 of the vehicle 10. The umbrella-receiving aperture 211 may be disposed at least a portion of the elongated member 110 between an end of the elongated member 210 within the hitch 11 and the opposing end of the elongated member 110 with respect to the hitch 11. Additionally, the umbrella-receiving aperture 211 may extend vertically from the elongated member 210 away from a ground surface.

The at least one seat attachment-receiving slot 212 may be disposed on at least a portion of the elongated member 110 between the end of the elongated member 210 within the hitch 11 and the opposing end of the elongated member 210 with respect to the hitch 11. Additionally, another at least one seat attachment-receiving slot 212 may be disposed on at least a portion of the elongated member 110, such that the at least one seat attachment-receiving slot 212 and the another at least on seat attachment-receiving slot 212 may have the umbrella 130 between them.

The seat attachment 120 may be removably connected to the at least one seat attachment-receiving slot 212 of the elongated member 210. Specifically, at least a portion of the attachment bar 121 may be inserted into the at least one seat attachment-receiving slot 212 and secured using a locking mechanism.

The extended member 214 may include a support member 214a, a first rod 214b, and a second rod 214c, but is not limited thereto.

The aperture 210a may be disposed within the opposing end of the elongated member 210 with respect to the hitch 11. The extended member 214 may be removably connected to the aperture 210a of the elongated member 210. Specifically, a width of the extended member 214 may be less than a width of the aperture 210a of the elongated member 210, such that the extended member 214 may be inserted therein. More specifically, the extended member 214 may extend a length of the elongated member 210. Moreover, the extended handle 213 may be rotated in the first direction or the second direction from a first position (i.e. unlocked) to a second position (i.e. locked), such that the extended member 214 may be prevented from further movement. Alternatively, the extended handle 213 may be rotated in the second direction or the first direction from the second position to the first position, such that the extended member 214 may move based on the user's preference.

The support member 214a may be perpendicularly disposed at an end of the extended member 214 opposite of an end inserted within the aperture 210a. Moreover, the support member 214a may extend a predetermined length toward the ground surface and in another predetermined length in an opposite direction away from the ground surface. Alternatively, the support member 214a may be adjustable using buttons, pins, and/or levers, and/or may be telescopically adjustable, such that the user may change the height of the support member 214a. The first support rod 214b may be disposed on at least a portion of the extended member 214. The second support rod 214c may be disposed on at least a portion of the extended member 214.

The first support rod 214b and the second support rod 214c may have a variety of attachments thereon as desired by the user, such as a surface structure (e.g., a table 20), an appliance (e.g., a grill 30), etc., but is not limited thereto. As such, the extended member 214 may increase useful options of the customizable vehicle attachment apparatus 200.

The customizable vehicle attachment apparatus 200 may be a convenient way to host a social gathering. Specifically, the user may sit on the at least one seat 122 instead of on and/or within the vehicle 10 to relax.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A vehicle attachment apparatus, comprising:
an elongated member removably connected to a hitch of a vehicle;
an umbrella removably connected to the elongated member to provide shade for a user that is positioned under the umbrella;
a seat attachment removably connected to the elongated member on a different higher plane from the elongated member with respect to a lateral direction and directly contacting the elongated member to support the user seated thereupon; and
an adjustment lever connected to the seat attachment to allow movement of the seat attachment in a first position, and prevent movement of the seat attachment in a second position.

2. The vehicle attachment apparatus of claim 1, wherein the seat attachment comprises:
at least one seat removably connected to the seat attachment to enable the user to sit.

3. The vehicle attachment apparatus of claim 2, wherein the at least one seat swivels in response to the user applying a force thereto.

4. The vehicle attachment apparatus of claim 2, wherein the seat attachment further comprises:
an attachment bar disposed transversely on top of the elongated member to support the at least one seat.

5. A vehicle attachment apparatus, comprising:
an elongated member removably connected to a hitch of a vehicle;
a support member connected to an end of the elongated member to provide vertical support therefor;
at least one seat attachment removably connected to the elongated member on a different higher plane from the elongated member with respect to a lateral direction and directly contacting the elongated member to support the user in response to the user sitting thereon; and
an adjustment lever connected to the seat attachment to allow movement of the seat attachment in a first position, and prevent movement of the seat attachment in a second position.

6. The vehicle attachment apparatus of claim 5, wherein the elongated member comprises:
an extended member removably connected to a portion of the elongated member to extend a length of the elongated member.

7. The vehicle attachment apparatus of claim 6, wherein a first end of the extended member is removably connected to the end of the elongated member, and a second end of the extended member is connected to the support member.

8. The vehicle attachment apparatus of claim 5, wherein the at least one seat attachment comprises:
at least one seat removably connected to the at least one seat attachment to enable the user to sit.

9. The vehicle attachment apparatus of claim 5, wherein the extended member supports at least one of a grill and a table.

10. The vehicle attachment apparatus of claim 5, further comprising:
an umbrella removably connected to the elongated member to provide shade for a user that is positioned under the umbrella.
